(19) United States
(12) Patent Application Publication
(10) Pub. No.: US 2026/0360610 A1
(43) Pub. Date: Nov. 12, 2026

(54) CURRENT TRANSFORMER WITH INTEGRATED SHORT-CIRCUIT BRIDGE

(71) Applicant: CELSA Messgeräte GmbH, Römerberg (DE)

(72) Inventors: Alois Bröder, Römerberg (DE); Denis Eckstädt, Römerberg (DE); Andreas Krumbacher, Römerberg (DE); Leonid Firus, Römerberg (DE); Daniel Schütz, Römerberg (DE); Stephan Wadle, Römerberg (DE); Artur Eckstädt, Römerberg (DE)

(21) Appl. No.: 19/205,080

(22) Filed: May 12, 2025

(51) Int. Cl. H01F 27/29; H01F 38/30

(52) U.S. Cl. CPC H01F 27/29; H01F 38/30

(57) ABSTRACT

The disclosure relates to a current transformer with a primary-circuit connector and a secondary circuit and with an integrated short-circuit bridge, wherein the short-circuit bridge is movable between a short-circuit position and an open position, so that secondary terminals of the secondary circuit are conductively connected to one another over the short-circuit bridge in the short-circuit position of the short-circuit bridge, wherein the short-circuit bridge is a spring which is relaxed in the open position and tensioned in the short-circuit position or which is tensioned in the open position and relaxed in the short-circuit position. The disclosure also relates to a transformer that includes a cover which covers the secondary terminals in the state of use and which is designed to be movable, in particular rotatable, so that the secondary terminals are uncovered in an open position.

### BACKGROUND AND FIELD

The present disclosure relates to a current transformer with an integrated short-circuit bridge.

Current transformers are transformers that convert or transform a current into a processable, in particular measurable current. In most cases, currents of high amperage and often high voltage are converted into smaller, e.g., measurable, values. In other words, a primary current is converted into a smaller, more useful secondary current, i.e., it is reduced or multiplied.

To this end, current transformers include a primary circuit and a secondary circuit. The current to be measured flows through the primary circuit and the secondary circuit provides the transformed current. The primary side often only comprises the conductor through which the current to be measured flows. The primary side is thus only connected to the current transformer, i.e., to its secondary circuit.

The secondary circuit must not be open when the primary circuit is energized, as otherwise high voltage peaks can occur. These can be destructive for the current transformer as well as dangerous for personnel.

It is thus desired that the secondary side, i.e., secondary circuit, should be short-circuited when work is carried out on the current transformer. This is often accomplished by means of short-circuit bridges that connect the secondary terminals.

For example, a short-circuit mechanism of an approximately square current transformer is disclosed in U.S. Pat. No. 3,208,021 B. In this patent, a short-circuit bridge is rotated into a conductive short-circuit position between the secondary terminals. To this end, a housing cover that is intended for the entire top side includes the secondary terminals and that has a central appendage. The central appendage engages, in a form-fitting manner, a central connector, which in turn is connected in a form-fitting manner to the plate-shaped short-circuit bridge so that, when the housing cover is turned, the appendage and thus the connector and the short-circuit bridge rotate centrally with a circular motion in order to connect the secondary terminals in a conductive manner by bringing them into contact with the plate ends, while the housing cover covers the entire top side including the secondary terminals. To turn or remove the housing cover, it is necessary to first loosen a screw lock.

The above described patented design is complex, and turning it can be difficult if the corresponding screw or its fastening nut is overtightened or if contaminants (e.g., dust) create resistance.

### SUMMARY

The present disclosure provides a simplified short-circuit mechanism for a transformer.

Advantageous embodiments are characterized in the subclaims and the description.

The disclosure is based on the insight that if the short-circuit bridge is a spring that is relaxed in the open position and tensioned in the short-circuit position, or vice versa, i.e., alternatively tensioned in the open position and relaxed in the short-circuit position, it is possible to simplify the short-circuiting/opening mechanism, as this mechanism makes it possible to produce a switching between the two positions and thus a short-circuiting of the secondary terminals by the spring.

In other words, by means of the relative movement of the spring, it can be ensured that the short-circuit position or open position, as desired, is adopted when the spring relaxes. Preferably, the tensioned position is the short-circuit position and the relaxed position is the open position. This also allows difficulties related to a turning to be avoided.

The short-circuit bridge is accordingly arranged and dimensioned between the secondary terminals of the secondary circuit in such a manner that it connects the secondary terminals in a conductive manner in the short-circuit position.

In one embodiment, the short-circuit bridge and the cover are designed in such a manner that, when the cover is moved into its open position, the short-circuit bridge is moved into the short-circuit position. This constrained coupling of the movements ensures a high level of safety.

When the short-circuit bridge is designed and arranged to be tensioned, in particular splayed or squeezed, by the movement of the cover so as to adopt the short-circuit position, the aforementioned return movement is easy to achieve.

The movement of the cover can cause in particular the rotation of a rotatable cam, the movement, i.e., rotation, of which causes the short-circuit bridge to adopt the short-circuit position. The rotation of the rotatable cam can be centric or eccentric. The rotatable cam can be designed so that one or both sides act on the short-circuit bridge.

For instance, an eccentric rotatable cam with a one-sided action could press the short-circuit bridge by means of its rotation against one of the two secondary terminals on one side, while the other secondary terminal is continuously contacted. The axis of rotation of the cam can lie on an axis of rotation of the cover.

In particular, the cover can include a centric or eccentric rotatable cam, in particular an elliptical projection, and the short-circuit bridge is designed to be moved from the open position to the short-circuit position by the movement of the rotatable cam.

For instance, it can be provided that the cover includes a rotatable cam with a two-sided action in the form of an elliptical projection and that the short-circuit bridge is designed to be moved by the elliptical projection from the open position to the short-circuit position as a result of the movement of the cover. The elliptical projection can face inwards and is preferably arranged centrally.

It is thus conceivable for the short-circuit bridge to have a U or V shape in cross section.

In a preferred variant, the cover and the short-circuit bridge are arranged in such a manner that the elliptical projection is suspended in the middle of the U or V shape and contacts and splays the legs of the short-circuit bridge in the open position of the cover in order to short-circuit the secondary terminals in the end position.

For instance, the cover can be turned to an open position, which in turn causes a rotation of the elliptical projection and thereby a contacting of the main vertex areas of the ellipse with the legs of the short-circuit bridge. This naturally causes the legs to splay so that-as mentioned-they touch the secondary terminals, which are thereby connected in a conductive manner. The axis of rotation of the elliptical projection preferably lies on the axis of rotation of the cover.

A further independent embodiment of the disclosure includes a cover for uncovering the secondary terminals in the open position.

The current transformer thus includes a cover which covers the secondary terminals in a state of use and which is designed to be movable, in particular rotatable, so that the secondary terminals are uncovered in an open position. An unintended contacting of the secondary terminals can thereby be prevented.

When the housing of the current transformer or arrangement of the secondary terminals is designed to be approximately rectangular when viewed in section (i.e., in a plan view of the secondary terminals), a 90-degree rotation of the thus elongate cover can be sufficient to switch between the open position and the closed position of use. To this end, it is preferable for the pivot point of the cover to be positioned in the middle between the externally arranged secondary terminals.

The cover can have a snap-in element by means of which it can be rotatably engaged with a counterpart element for a detachable attachment to the housing. Preferably, the snap-in element and the counterpart element are arranged concentrically around the elliptical projection.

The cover can also have a preferred direction of rotation, e.g. counter-clockwise. Moreover, the underside of the cover can include a curb that only allows this rotation.

In the present disclosure, primary-circuit connector denotes that the current transformer includes a connector for connection to an internal or external primary circuit.

A further embodiment of the disclosure includes coupling points for coupling with other components. These coupling points can render possible, e.g., a snap-on or form-fitting connection of other components or current transformers.

If the current transformer has a quadrilateral housing when viewed in section, coupling points can be provided at all outer corners. Preferably, the coupling points are formed in the corner areas of the flat front sides and rear sides.

This also makes it possible to couple a plurality of current transformers according to the disclosure to one another in order to provide, e.g., a three-phase set of current-transformers.

Further potential components are mounting adapters, e.g. for a mounting on plates or top-hat rails, such as, e.g., clip-on feet.

The coupling points can take the form of V- or L-shaped openings that connect the flat front and rear sides of the housing, wherein the legs of the V or L run around the corner.

The special design of the “outside corners” enables a maximum freedom when mounting the current transformer on a busbar, on mounting plates and on top-hat rails. It is also possible to thread cable ties through them for all kinds of attachments.

A further independent embodiment of the disclosure includes the potentially provided central through opening, which is designed to be symmetrical, preferably with a rotational symmetry C4 in section.

The through opening is preferably designed so as to be stepped in the quadrants of its periphery in order to accommodate conductors of different dimensions.

In one embodiment, the central through opening can include dovetail-like recesses in the 12 o'clock, 3 o'clock, 6 o'clock and 9 o'clock positions, which render possible an interlocking attachment. For example, a primary-rail terminal can be inserted in these recesses, by means of which a primary conductor inserted in the central through opening can be fixed using screws, threaded rods, etc.

The current transformers according to the disclosure are preferably slip-on/wound current transformers, cable conversion current transformers, rail conversion current transformers, protective current transformers, summation current transformers, residual-current current transformers or current transformers with measuring transducers.

The current transformers according to the disclosure are particularly suitable for primary rated currents of up to 6000 Amps (A).

Further details of the disclosure are disclosed in the following description of example embodiments with reference to the drawings.

### BRIEF DESCRIPTION OF THE DRAWINGS

FIG. 1A is a schematic perspective view of a slip-on current transformer according to the disclosure with the cover in the closed position;

FIG. 1B is a schematic perspective view of the slip-on current transformer with the cover in the open position;

FIG. 1C is a front view of the slip-on current transformer with the cover in a closed position;

FIG. 2A is a partially sectioned front view of the slip-on current transformer of FIGS. 1A-1C with the cover in the fully open position;

FIG. 2B is a partially sectioned front view of the slip-on current transformer with the cover in a half-open position;

FIG. 2C is a partially sectioned front view of the slip-on current transformer with the cover in the fully closed position;

FIG. 3A is a bottom perspective view of the cover of FIGS. 1A-1C;

FIG. 3B is an end view of the cover of FIG. 3A;

FIG. 3C is a bottom plan view of the cover of FIG. 3A;

FIG. 3D is a side view of the cover of FIG. 3C;

FIG. 3E is a longitudinal cross-section of the cover taken along line IIIE-IIIE of FIG. 3B;

FIG. 3F is a cross-section view of the cover taken along line IIIF-IIIF of FIG. 3B;

FIG. 4A is a partially sectioned front view of the housing of FIGS. 1A-1C;

FIG. 4B is a side view of the housing of FIG. 4A;

FIG. 4C is a perspective view of the housing of FIG. 4A;

FIG. 4D is an enlarged cross-section view of the housing taken along line IVD-IVD of FIG. 4B;

FIG. 4E is an enlarged cross-section view of the housing taken along line IVE-IVE of FIG. 4A;

FIG. 4F is a front view of the housing of FIG. 4A;

FIG. 5A a partial sectioned view of the housing and cover of FIGS. 1A-1C;

FIG. 5B is a side view of the housing and cover of FIG. 5A;

FIG. 5C is an enlarged cross-section view of the housing and cover taken along line VC-VC of FIG. 5A;

FIG. 5D is an enlarged cross-section view of the housing and cover taken along line VD-VD of FIG. 5B;

FIG. 6A a partially sectioned front view of the transformer of FIGS. 1A-1C with the cover in the closed position;

FIG. 6B a partial cross-section view taken along line VIB-VIB of FIG. 6A;

FIG. 6C is an enlarged perspective view of a short-circuit bridge of FIG. 6B;

FIG. 7A a partially sectioned front view of the transformer of FIGS. 1A-1C with the cover in the partially open position;

FIG. 7B a partial cross-section view taken along line VIIB-VIIB of FIG. 7A;

FIG. 8A a partially sectioned front view of the transformer of FIGS. 1A-1C with the cover in the fully open position;

FIG. 8B a partial cross-section view taken along line VIIIB-VIIIB of FIG. 8A;

FIG. 9 a schematic perspective view of an attachment of the current transformer of FIG. 1 to a busbar;

FIG. 10 a schematic perspective view of an alternative attachment of the current transformer of FIG. 1 to a busbar;

FIG. 11 a schematic perspective view of an attachment of the current transformer of FIG. 1 to a top-hat rail; and

FIG. 12 a schematic perspective view of an attachment of the current transformer of FIG. 1 to a plate.

### DESCRIPTION OF THE PREFERRED EMBODIMENTS

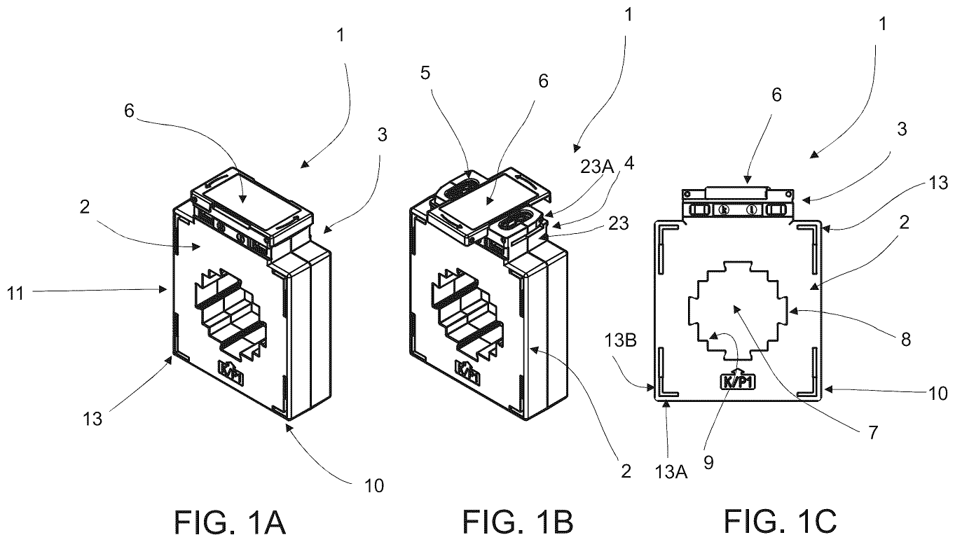

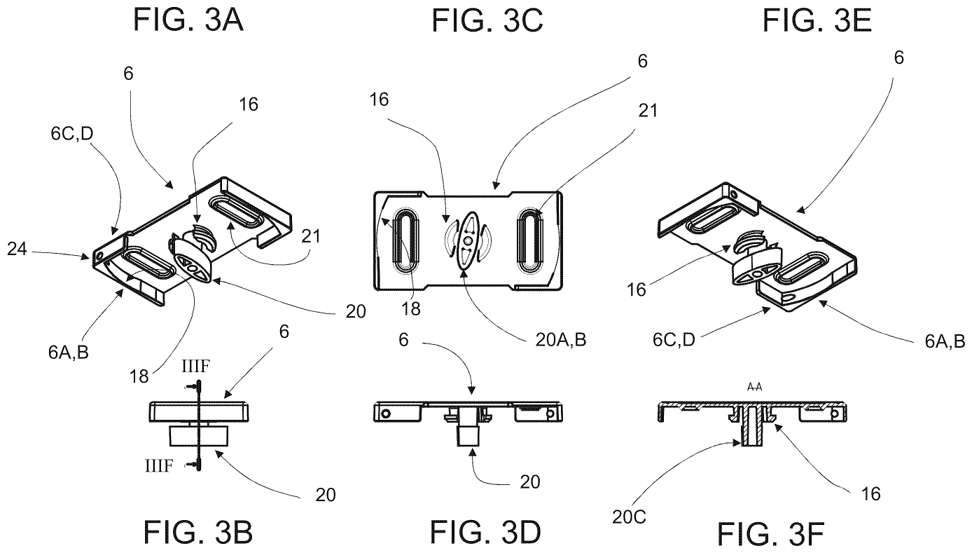

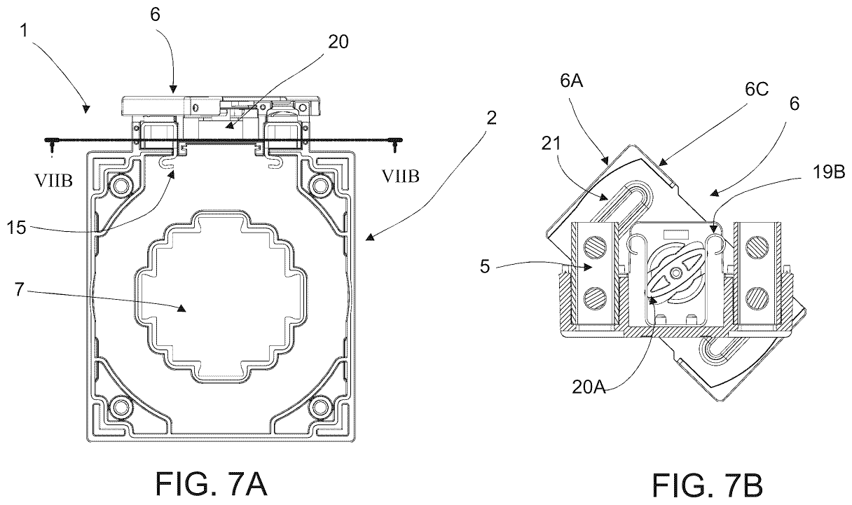

FIGS. 1 to 8 show different views of the structure of a current transformer according to the disclosure, which is designated as a whole by 1 and which is designed as a slip-on transformer.

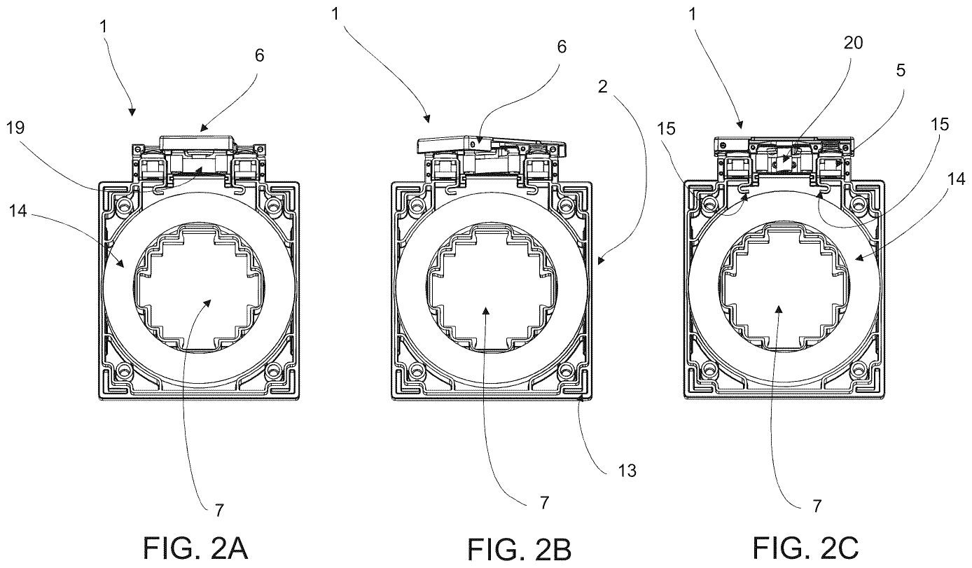

The current transformer 1 includes a housing 2, which is designed to be approximately square when viewed from the front and rectangular when viewed from above, and which includes, on the head area 3, a protruding smaller terminal area 4 for the secondary terminals 5 that can be covered (see FIG. 1A or FIG. 2C) or uncovered (see FIG. 1B or FIG. 2A) by a rotatable cover 6.

Arranged approximately in the centre of the housing 2 in the front view or front side is a central through opening 7, which has a rotational symmetry C4 in section and dovetail-like recesses 8 in the 12 o'clock, 3 o'clock, 6 o'clock and 9 o'clock positions, wherein the side walls 9 of the central through opening 7 are designed to be stepped.

Coupling points 13 in the form of L-shaped openings that connect the flat front and rear sides of the housing 2 are formed at the outside corners 10 of the front and rear sides 11, 12, wherein the legs 13A, B of the L run around the corner.

As is clearly visible in FIGS. 2A-2C, 4A, 4B and 5A, an approximately circular installation space 14 surrounds the central through opening 7 inside the housing 2, e.g., for the accommodation of secondary circuit windings or coils (not shown).

These can be connected to terminal clamping plates 15 of the secondary terminals 5.

As the housing 2 of the current transformer 1 or arrangement of the secondary terminals 5 is designed to be approximately rectangular when viewed in section (i.e., in a plan view of the secondary terminals), a 90-degree rotation of the thus elongate cover 6 is sufficient to switch between the open position and the closed position of use. The pivot point of the cover 6 is positioned in the middle between the externally arranged secondary terminals 5.

The cover 6 has a snap-in element 16 by means of which it can be rotatably engaged with a counterpart element 17 for a detachable attachment to the housing 2. The snap-in element 16 and the counterpart element 17 are arranged concentrically around the elliptical projection and form the central pivot point.

The cover 6 also has a preferential anticlockwise direction of rotation, which is achieved by means of a curb 18 on the underside of the cover 6, which, in cooperation with the walls of the smaller terminal area 4 for the secondary terminals 5, only allows this rotation.

A short-circuit bridge 19 made of conductive spring material has a U shape in cross section and is arranged around the pivot point in order to be splayed by the movement (rotation around the pivot point) of the cover in order to adopt the short-circuit position.

To this end, the cover 6 includes a rotatable cam in the form of an elliptical projection 20 and the short-circuit bridge 19 is splayed by the elliptical projection from the open position to the short-circuit position as a result of the movement of the cover, to which end the elliptical projection 20 on the underside of the cover faces inwards and is preferably arranged centrally inside the snap-in element 16, i.e., at the pivot point.

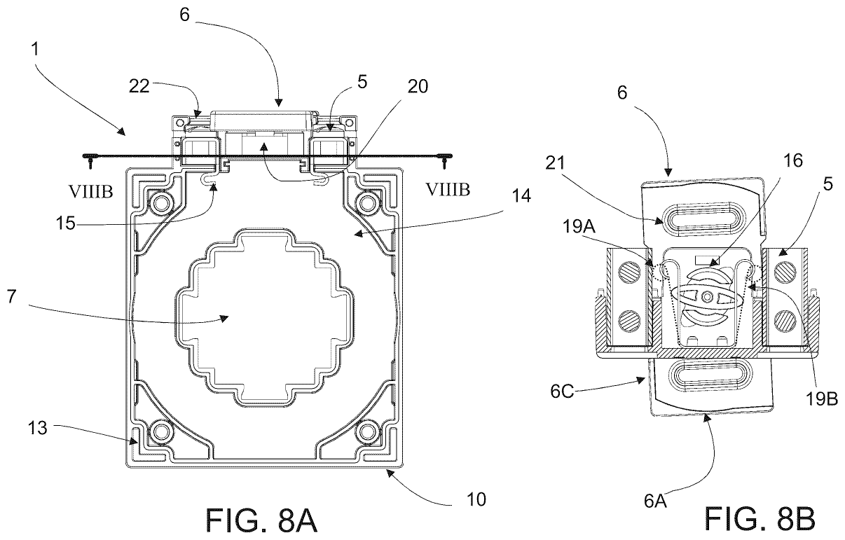

The cover 6 and the short-circuit bridge 19 are thus arranged in such a manner that the elliptical projection 20 is suspended in the middle of the U shape of the short-circuit bridge 19 and splays the legs 19A, B of the latter in the open position of the cover 6 (see FIG. 8, dotted legs 19A, B), which are thus pressed against the laterally arranged secondary terminals 5, thus short-circuiting them.

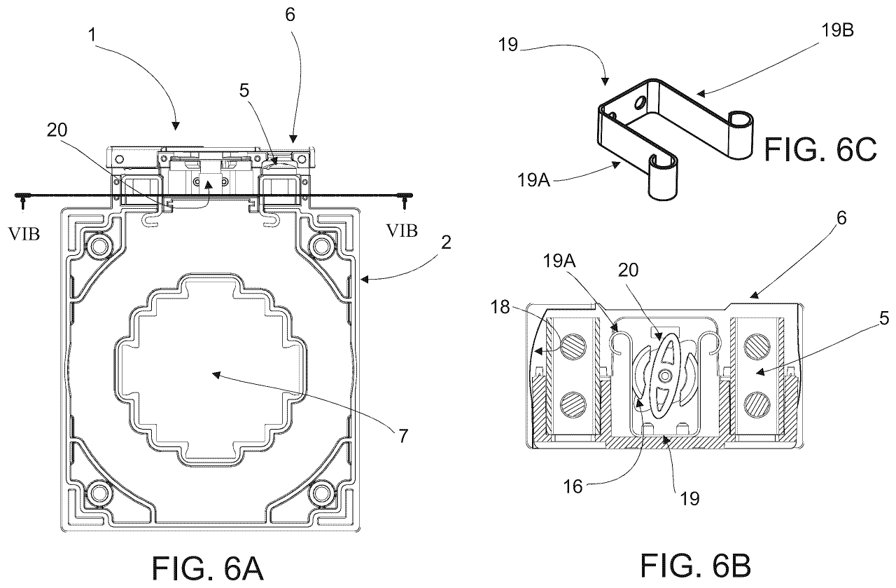

To open it, the cover 6 can thus be turned anticlockwise around the pivot point, which in turn causes a rotation of the elliptical projection 20 around the pivot point and thereby a contacting of the main vertex areas 20A, B of the ellipse with the legs 19A, B of the short-circuit bridge 19, which causes the legs 19A, B to splay against the spring force so that—as mentioned—they touch the secondary terminals 5 arranged laterally thereto, which are thereby connected in a conductive manner. This is clearly visible in FIGS. 6A-6C, 7A, 7B, 8A, and 8B.

The cover 6 includes oval engaging protrusions 21 on its underside, which, when the cover is in the closed position, match the recessed contact surfaces 22 of the secondary terminals 5, so that the cover 6 is also locked in place there in the closed position and the secondary terminals 5 are covered in a dust-tight manner.

Consistent with the preferred anticlockwise direction of rotation of the cover 6, the walls 23 of the smaller terminal area 4 for the secondary terminals 5 include bevelled or rounded wall areas 23A analogous to the course of the curbs 18.

The cover 6 includes a side wall 6A, B on each end side and a partial longitudinal-side wall 6C, D contiguous with the side wall 6A, B, wherein the partial longitudinal-side walls 6C, D respectively abuts the corresponding wall 23 when the cover 6 is in the closed position. Since the remaining area of the longitudinal sides is free, a rotation is not impeded. A closure hole 24 can also be provided in the side walls 6A, B, C, D, which has a counterpart 25 in the terminal area 4.

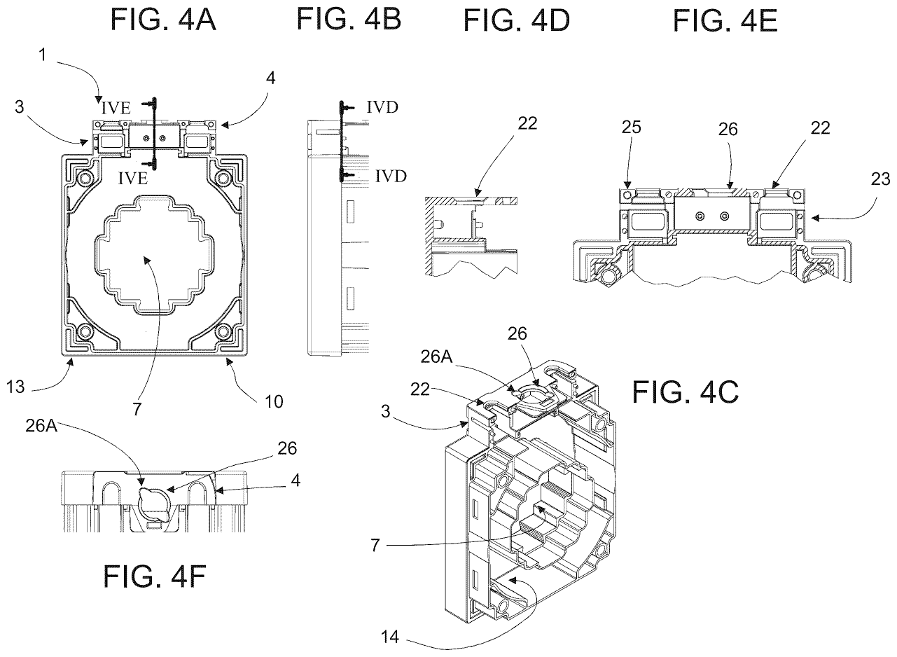

A circular opening 26 (see FIGS. 4C and 4E) in the terminal area 4, which includes two opposite extensions 26A, is used to attach the cover 6 to the housing 2, so that the elliptical projection 20 can be inserted through it and then rotated about its shaft 20C of a reduced diameter.

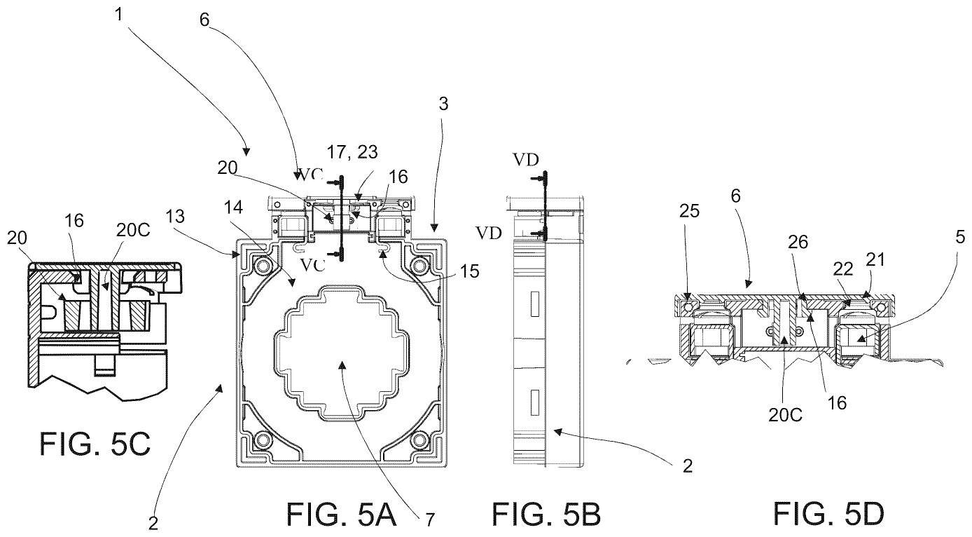

If the cover 6 is now pressed in further, the snap-in element 16 snaps with its projections into the circular opening 26 and engages its periphery in a form-fitting manner (see FIGS. 5C and 5D). The circular opening 26 thus forms the counterpart element 17.

The snap-in element 16 and the counterpart element 17 or circular opening 26 are arranged concentrically around the elliptical projection 20 and form the central pivot point. This simultaneously produces a guide for the rotational movement.

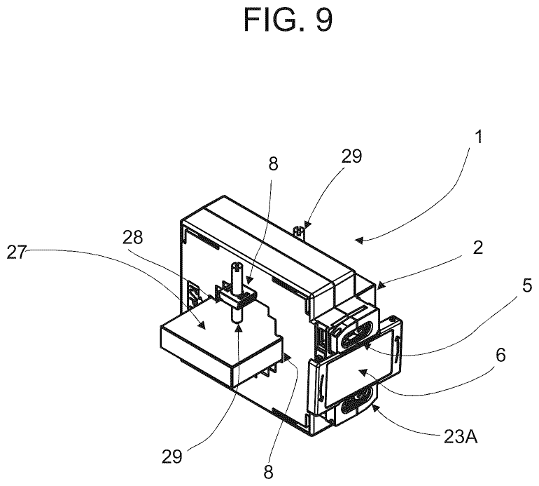

FIGS. 9-12 illustrate example attachment options.

In FIG. 9, a busbar 27 is guided through the central through opening 7 of the current transformer 1 and fixed on both sides of the circular opening 7 by means of a locking element 28.

The locking element 28 is respectively inserted into the corresponding dovetail-like recesses 8 and fixes the busbar 27 by means of a screw 29 received in a threaded hole.

The busbar 27 itself is inserted laterally into opposite dovetail-like recesses 8 and thus held in an interlocking manner.

The cover 6 is shown rotated by 90 degrees in the open position.

In comparison with the terminal area 4 or the cover 6, the current transformer 1 is on its side, so to speak.

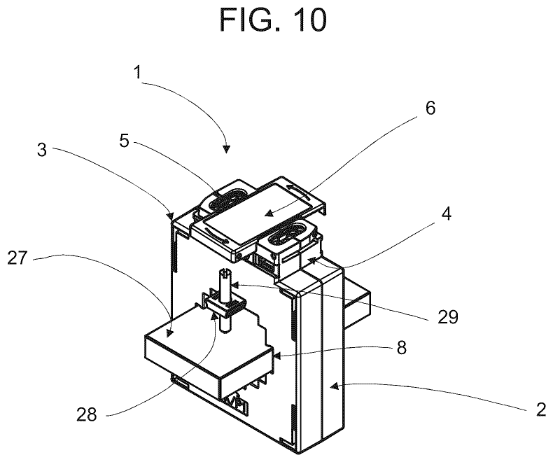

FIG. 10, on the other hand, shows an upright attachment to the busbar 27. The viability of the attachment options is evident.

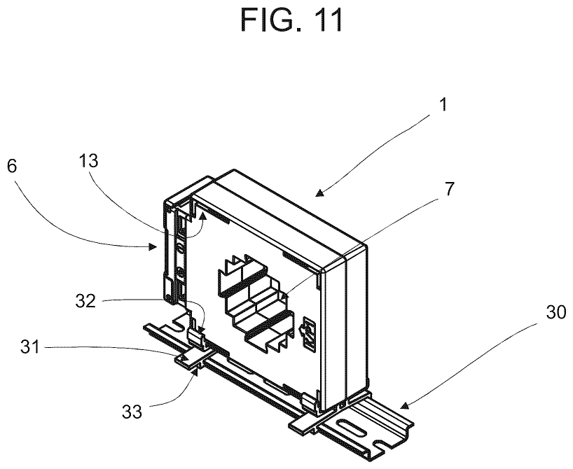

In FIG. 11, in contrast, the current transformer 1 is clamped onto a top-hat rail 30 in an arrangement lying on its side.

Interlocking parts 31 are provided to this end, which engage the respective coupling points 13 on one side by means of snap-on elements 32 and which grasp the top-hat rail 30 on the other side by means of snap-on elements 33.

The cover 6 is shown in the closed position.

It is evident that the alignment of the current transformer 1 with the top-hat rail 30 depends solely on the use of the respective coupling points 13.

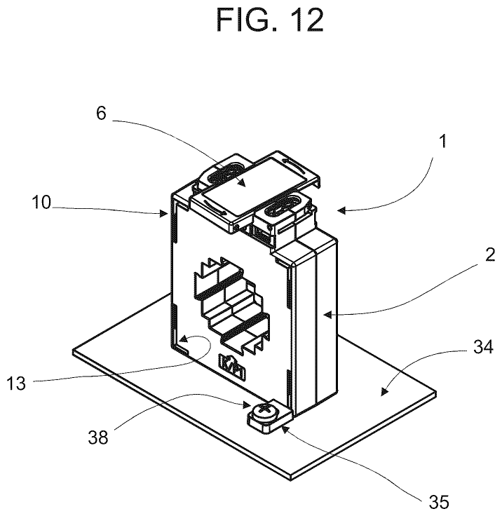

In FIG. 12, the current transformer 1 is screwed in an upright position to a plate 34.

Screw parts 35 are provided to this end, which are inserted into the respective coupling points 13 in an interlocking manner on one side and which are designed with holes for screws 38 on the other.

The cover 6 is shown rotated by 90 degrees in the open position.

1. A current transformer comprising:
a primary-circuit connector;
a secondary circuit having secondary terminals; and
an integrated short-circuit bridge, wherein the short-circuit bridge is movable between a short-circuit position and an open position, so that secondary terminals of the secondary circuit are conductively connected to one another over the short-circuit bridge in the short-circuit position of the short-circuit bridge, and wherein the short-circuit bridge comprises a spring, the spring being relaxed in the open position and tensioned in the short-circuit position or which is tensioned in the open position and relaxed in the short-circuit position.

2. A current transformer comprising:
a primary-circuit connector;
a secondary circuit having secondary terminals; and
an integrated short-circuit bridge, wherein the short-circuit bridge is movable between a short-circuit position and an open position, so that secondary terminals of the secondary circuit are conductively connected to one another over the short-circuit bridge in the short-circuit position of the short-circuit bridge, and wherein the current transformer includes a cover, the cover covering the secondary terminals in a state of use and operable to be rotatably movable into an open position in which the secondary terminals are uncovered.

3. The current transformer according to claim 1, wherein the short-circuit bridge and the cover are designed in such a manner that, when the cover is moved into the open position, the short-circuit bridge is moved into the short-circuit position.

4. The current transformer according to claim 3, wherein the short-circuit bridge is configured to be relaxed or tensioned, in particular splayed, by the movement of the cover so as to adopt the short-circuit position.

5. The current transformer according to claim 3, wherein the cover includes a rotatable cam, in particular an elliptical projection, and the short-circuit bridge is designed to be moved from the open position to the short-circuit position by the movement of the rotatable cam.

6. The current transformer according to claim 5, wherein the short-circuit bridge has a U or V shape in cross section.

7. The current transformer according to claim 6, wherein the cover and the short-circuit bridge are arranged in such a manner that the rotatable cam, in particular the elliptical projection, is suspended in the middle of the U or V shape and contacts and splays the legs in the open position of the cover.

8. The current transformer according to claim 1, wherein the current transformer includes a housing, the housing has a quadrilateral shape when viewed in section and which includes coupling points, preferably at all outer corners.

9. The current transformer according to claim 8, wherein the coupling points take the form of V- or L-shaped openings that connect the flat front and rear sides of the housing, wherein the legs of the V or L run around the corner.

10. The current transformer according to claim 1, wherein the current transformer includes a central through opening that is designed to be symmetrical, preferably with a rotational symmetry C4 in section.

11. The current transformer according to claim 10, wherein the central through opening includes dovetail-like recesses in the 12 o'clock, 3 o'clock, 6 o'clock and 9 o'clock positions.

12. The current transformer according to claim 2, wherein the short-circuit bridge and the cover are designed in such a manner that, when the cover is moved into the open position, the short-circuit bridge is moved into the short-circuit position.

13. The current transformer according to claim 12, wherein the short-circuit bridge is designed and arranged to be relaxed or tensioned, in particular splayed, by the movement of the cover so as to adopt the short-circuit position.

14. The current transformer according to claim 13, wherein the cover includes a rotatable cam, in particular an elliptical projection, and the short-circuit bridge is designed to be moved from the open position to the short-circuit position by the movement of the rotatable cam.

15. The current transformer according to claim 14, wherein the short-circuit bridge has a U or V shape in cross section.

16. The current transformer according to claim 15, wherein the cover and the short-circuit bridge are arranged in such a manner that the rotatable cam, in particular the elliptical projection, is suspended in the middle of the U or V shape and contacts and splays the legs in the open position of the cover.

17. The current transformer according to claim 2, wherein the current transformer includes a housing has a quadrilateral shape when viewed in section and which includes coupling points, preferably at all outer corners.

18. The current transformer according to claim 17, wherein the coupling points take the form of V-or L-shaped openings that connect the flat front and rear sides of the housing, wherein the legs of the V or L run around the corner.

19. The current transformer according to claim 2, wherein the current transformer includes a central through opening that is designed to be symmetrical, preferably with a rotational symmetry C4 in section.

20. The current transformer according to claim 19, wherein the central through opening includes dovetail-like recesses in the 12 o'clock, 3 o'clock, 6 o'clock and 9 o'clock positions.
